(19) United States
(12) Patent Application Publication
(10) Pub. No.: US 2023/0373496 A1
(43) Pub. Date: Nov. 23, 2023

(54) VEHICLE CONTROL DEVICE AND VEHICLE CONTROL METHOD

(71) Applicant: DENSO CORPORATION, Kariya-city (JP)

(72) Inventors: Takeshi YAMAMOTO, Kariya-city (JP); Shizuka YOKOYAMA, Kariya-city (JP); Kiyotaka TAGUCHI, Kariya-city (JP)

(21) Appl. No.: 18/363,259

(22) Filed: Aug. 1, 2023

Related U.S. Application Data
(63) Continuation of application No. PCT/JP2022/001359, filed on Jan. 17, 2022.

(30) Foreign Application Priority Data
Feb. 5, 2021 (JP) 2021-017660

(51) Int. Cl. B60W 40/09; B60W 50/10; G06V 20/59

(52) U.S. Cl. CPC B60W 40/09; B60W 50/10; G06V 20/597; B60W 2540/00

(57) ABSTRACT

In a technique for vehicle control, a gesture due to a motion of a body part of an occupant of a vehicle is detected. The gesture is associated with an operation of an in-vehicle device provided in the vehicle. The in-vehicle device executes the operation associated with the gesture. The in-vehicle device executes position-specific operations that are different for respective positions in a vehicle cabin of the vehicle. The gesture requires a line motion of the body part. Different operations of the position-specific operations are associated with gestures detected as a common gesture according to a direction of trajectory deviation. The trajectory deviation is deviation of a trajectory of a line motion of the body part detected as the common gesture from a trajectory of the line motion required by the common gesture.

### CROSS REFERENCE TO RELATED APPLICATIONS

The present application is a continuation application of International Patent Application No. PCT/JP2022/001359 filed on Jan. 17, 2022, which designated the U.S. and claims the benefit of priority from Japanese Patent Application No. 2021-017660 filed on Feb. 5, 2021. The entire disclosures of all of the above applications are incorporated herein by reference.

### TECHNICAL FIELD

The present disclosure relates to a vehicle control device and vehicle control method.

### BACKGROUND

A technique of gesture operation is known, in which a gesture using a part of a body of a user is detected and an operation according to the gesture is executed.

### SUMMARY

According to at least one embodiment of the present disclosure, a gesture due to a motion of a body part of an occupant of a vehicle is detected. The gesture is associated with an operation of an in-vehicle device provided in a vehicle. The in-vehicle device is caused to execute the operation with the gesture. The in-vehicle device is caused to execute position-specific operations that are different for respective positions in a vehicle cabin of the vehicle. The gesture that requires a line motion of the body part is detected. Different operations of the position-specific operations are associated with gestures detected as a common gesture according to a direction of trajectory deviation. The trajectory deviation is deviation of a trajectory of a line motion of the body part detected as the common gesture from a trajectory of the line motion required by the common gesture.

### BRIEF DESCRIPTION OF THE DRAWINGS

The details of one or more embodiments are set forth in the accompanying drawings and the description below. Other features and advantages will be apparent from the description and drawings, and from the claims.

FIG. 1 is a schematic diagram illustrating a configuration of a vehicle system according to a first embodiment.

FIG. 2 is a diagram illustrating an arrangement of a first display and a second display.

FIG. 3 is a diagram illustrating a configuration of an HCU according to the first embodiment.

FIG. 4 is a diagram illustrating a distinction between a first gesture and a second gesture.

FIG. 5 is a diagram illustrating a trajectory of a gesture.

FIG. 6 is a diagram illustrating a trajectory of a gesture.

FIG. 7 is a diagram illustrating a trajectory of a gesture.

FIG. 8 is a diagram illustrating a trajectory of a gesture.

FIG. 9 is a diagram illustrating display of information for position-specific operations.

FIG. 10 is a diagram illustrating FB display.

FIG. 11 is a flowchart illustrating a position-specific process in the HCU according to the first embodiment.

FIG. 12 is a flowchart illustrating a process related to the FB display in the HCU according to the first embodiment.

FIG. 13 is a schematic diagram illustrating a configuration of a vehicle system according to a second embodiment.

FIG. 14 is a schematic diagram illustrating a configuration of an HCU according to the second embodiment.

FIG. 15 is a flowchart illustrating a FB display process in the HCU according to the second embodiment.

### DETAILED DESCRIPTION

To begin with, examples of relevant techniques will be described. According to a comparative example, a mobile phone stores different applications in association with respective fingers. When a gesture using an arbitrary finger is recognized, a process based on an input operation associated with the finger is executed.

In gesture operation, unlike input to a button display, an operation corresponding to a gesture can be executed by the gesture even when any screen is displayed. Therefore, it may be possible to save the effort of switching to a screen showing a button for performing a desired operation and then pressing the button for input.

However, if different gestures are associated with respective operation contents, the burden on the user may increase. More specifically, the user needs to memorize the correspondence relationship between the operation contents and the five fingers, thereby increasing the burden on the user.

In contrast, it is conceivable to associate a common gesture with multiple operation contents. In this case, it may be required to accurately associate the common gesture with the different operation contents as necessary. For example, in a case where an operation is performed for each of seats of a vehicle separately, since the gesture is common, it is required to specify a seat where an occupant has performed a gesture and execute the operation corresponding to the seat of the occupant who has performed the gesture.

In contrast to the comparative example, a vehicle control device and a vehicle control method of the present disclosure are capable of executing multiple operations by using a common gesture and also capable of executing the operations meeting necessities more accurately.

According to an aspect of the present disclosure, a vehicle control device includes a processor and a memory that stores instructions. When the instructions are executed by the processor, the instructions cause the processor to execute the following process. A gesture due to a motion of a body part of an occupant of a vehicle is detected. The gesture is associated with an operation of an in-vehicle device provided in the vehicle. The in-vehicle device is caused to execute the operation associated with the gesture. The in-vehicle device is caused to execute position-specific operations that are different for respective positions in a vehicle cabin of the vehicle. The gesture that requires a line motion of the body part is detected. Different operations of the position-specific operations are associated with gestures detected as a common gesture according to a direction of trajectory deviation. The trajectory deviation is deviation of a trajectory of a line motion of the body part detected as the common gesture from a trajectory of the line motion required by the common gesture.

According to another aspect of the present disclosure, a vehicle control method is executed by at least one processor. In the method, a gesture due to a motion of a body part of an occupant of a vehicle is detected. The gesture detected is associated with an operation of an in-vehicle device provided in the vehicle. The in-vehicle device is caused to execute the operation associated with the gesture. The in-vehicle device is caused to execute position-specific operations that are different for respective positions in a vehicle cabin of the vehicle. The gesture that requires a line motion of the body part is detected. Different operations of the position-specific operations are associated with gestures detected as a common gesture according to a direction of trajectory deviation. The trajectory deviation is deviation of a trajectory of a line motion of the body part detected as the common gesture from a trajectory of the line motion required by the common gesture.

The trajectory of the gesture that requires the line motion of the body part generally has a specific tendency in deviation direction according to a position of the occupant relative to a position at which the gesture is detected. This is because a range in which the body part used for the gesture is easily moved differs depending on the position of the occupant relative to the position where the gesture is detected. Regarding this, according to the above configuration, different operations of the position-specific operations are associated with gestures detected as the common gesture according to the direction of deviation of the trajectory of the line motion of the body part detected as the common gesture from the trajectory of the line motion required by the common gesture. Then, the associated operation is executed. Therefore, the common gesture can cause execution of the different position-specific operations according to the position of the occupant relative to the position at which the gesture is detected. Therefore, the position-specific operations can be executed according to the position of the occupant who has performed the gesture. As a result, different operations can be executed using the common gesture while operations meeting necessities can be executed more accurately.

Multiple embodiments will be described with reference to the drawings. For convenience of description, portions having the same functions as those illustrated in the drawings used in the description among embodiments are assigned the same reference symbol, and descriptions of the same portions may be omitted. Descriptions in another embodiment may be referred to for the portions assigned the same reference symbol.

### First Embodiment

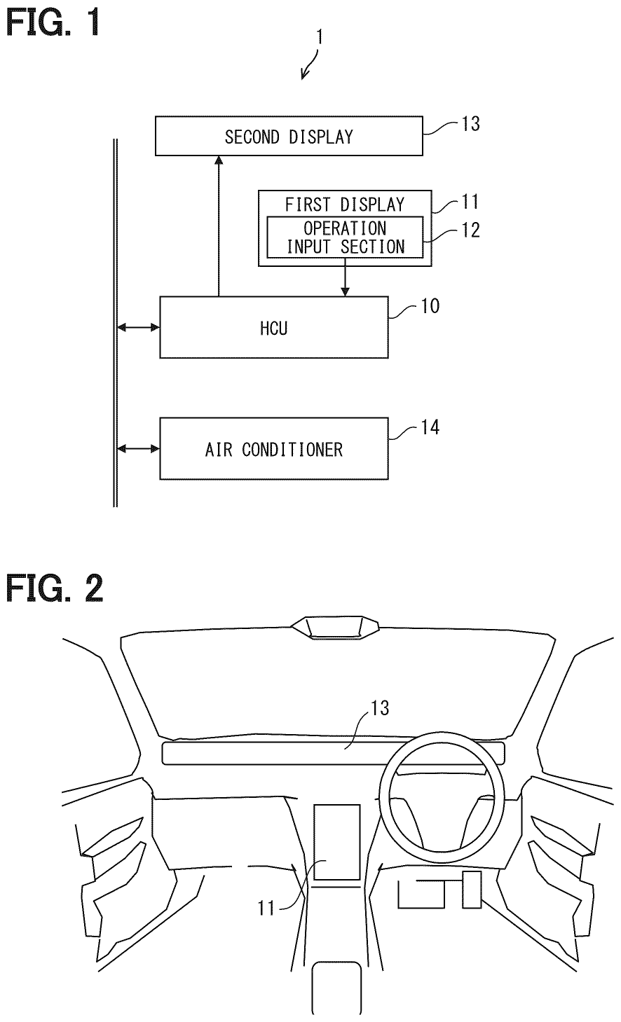

Hereinafter, a first embodiment of the present disclosure will be described with reference to the drawings. A vehicle system 1 illustrated in FIG. 1 can be used in an automobile (hereinafter, simply a vehicle). As illustrated in FIG. 1, the vehicle system 1 includes an HCU 10 (i.e., Human Machine Interface Control Unit), a first display 11, an operation input section 12, a second display 13, and an air conditioner 14. The HCU 10 and the air conditioner 14 are connected to, for example, an in-vehicle LAN. Hereinafter, a vehicle using the vehicle system 1 is referred to as a subject vehicle.

The first display 11 has a display screen located at a position other than a position in front of a driver's seat of the subject vehicle. As illustrated in FIG. 2, the first display 11 may be, for example, a CID (i.e., Center Information Display) disposed at the center of an instrument panel of the subject vehicle. The first display 11 executes various displays on the display screen based on information outputted from the HCU 10. For example, a guide screen related to a navigation function, an operation screen of an air conditioner, and an operation screen of an audio device are displayed on the first display 11. The first display 11 is a touch panel including the operation input section 12.

The operation input section 12 is provided in a vehicle cabin of the subject vehicle and receives an operation input from an occupant of the subject vehicle. The operation input section 12 receives an input of a gesture by a motion of a body part of the occupant in the subject vehicle. The operation input section 12 corresponds to an input device. In the following descriptions, the body part used for the gesture is, for example, a finger. The operation input section 12 is a position input device. That is, the operation input section 12 detects a position touched by a finger on the display screen of the first display 11, and outputs information of the position as position information to the HCU 10. The position information is represented by coordinates of two orthogonal axes. Hereinafter, as an example, it is assumed that the position information is represented by coordinates of an X axis corresponding to the right-left direction of the subject vehicle and a Y axis corresponding to the up-down direction of the subject vehicle. Since the display screen of the first display 11 may be inclined with respect to the up-down direction of the subject vehicle, the up-down direction may be slightly tilted from the up-down direction of the subject vehicle, for example, by from 1 to 15 degrees. The same applies to the right-left direction. The operation input section 12 may be a capacitive touch sensor provided behind the display screen of the first display 11. The operation input section 12 is not limited to the capacitive touch sensor, and may be a touch sensor of another type such as a pressure sensitive sensor.

The second display 13 has a display screen extending at least from the front of the driver's seat to the front of a passenger's seat of the subject vehicle. As shown in FIG. 2, the second display 13 may have the display screen extending from a left A pillar to a right A pillar of the subject vehicle. The second display 13 may be implemented by a single display. The second display 13 may be realized by multiple displays arranged in the vehicle width direction. One of the displays may be an upper one of two vertically-divided screens of the first display 11. In this case, the display area of the upper screen corresponds to the second display, and the display area of the lower screen corresponds to the first display. The display screen of the second display 13 is provided at a position where the driver can easily check the second display 13 while looking ahead of the vehicle. The second display 13 does not have a touch panel function. That is, the second display 13 does not include the operation input section 12.

The air conditioner 14 acquires, from the HCU 10, information of an air conditioning request. This information includes setting values related to air conditioning set by the occupant of the subject vehicle. Then, in accordance with the information of the air conditioning request, the air conditioner 1 executes air conditioning, more specifically, executes adjustment of air to be blown out from multiple air outlets provided in the subject vehicle. The air conditioning executed by the air conditioner 14 includes adjustment in temperature of conditioned air, and adjustment in air volume of the conditioned air. The air conditioner 14 corresponds to an in-vehicle device provided in a vehicle.

The air outlets of the air conditioner 14 are provided so as to be capable of blowing conditioned air individually to at least the driver's seat and the passenger's seat. For example, air outlets for blowing the conditioned air to the driver's seat may be provided on left and right sides a portion in front of the driver's seat, respectively. The air outlets through which the conditioned air is blown to the driver's seat are hereinafter referred to as driver's-seat air outlets. On the other hand, air outlets for blowing the conditioned air to the passenger's seat may be provided on left and right sides a portion in front of the passenger's seat, respectively. The air outlets through which the conditioned air is blown to the passenger's seat are hereinafter referred to as passenger's-seat air outlets.

The air conditioner 14 can be operated in different operations depending on a position in a vehicle cabin of the subject vehicle. In an example of the present embodiment, the air conditioner 14 can be operated to execute temperature adjustment at the driver's seat and temperature adjustment at the passenger's seat separately as the different operations. That is, temperatures at the driver's seat and the passenger's seat can be adjusted to be different from each other. In addition, the air conditioner 14 can be operated to execute air-volume adjustment at the driver's seat and air-volume adjustment at the passenger's seat separately as the different operations. That is, air volumes at the driver's seat and the passenger's seat can be adjusted to be different from each other. Hereinafter, operations different for respective positions in the vehicle cabin of the subject vehicle are referred to as position-specific operations. The position-specific operations are, for example, operations different for positions rightward and leftward of the operation input section 12 in a right-left direction of the subject vehicle.

The HCU 10 mainly includes a microcontroller including a processor, a memory, an I/O (i.e., Input/Output), and a bus connecting these components. The HCU 10 executes a control program (i.e., instructions) stored in the memory to perform various processes related to information exchange between the occupant and the system of the subject vehicle. The HCU 10 corresponds to a vehicle control device. The memory referred to herein is a non-transitory tangible storage medium that non-temporarily stores computer-readable programs and data. The non-transitory tangible storage medium is realized by a semiconductor memory, a magnetic disk, or the like. Details of the HCU 10 will be described below.

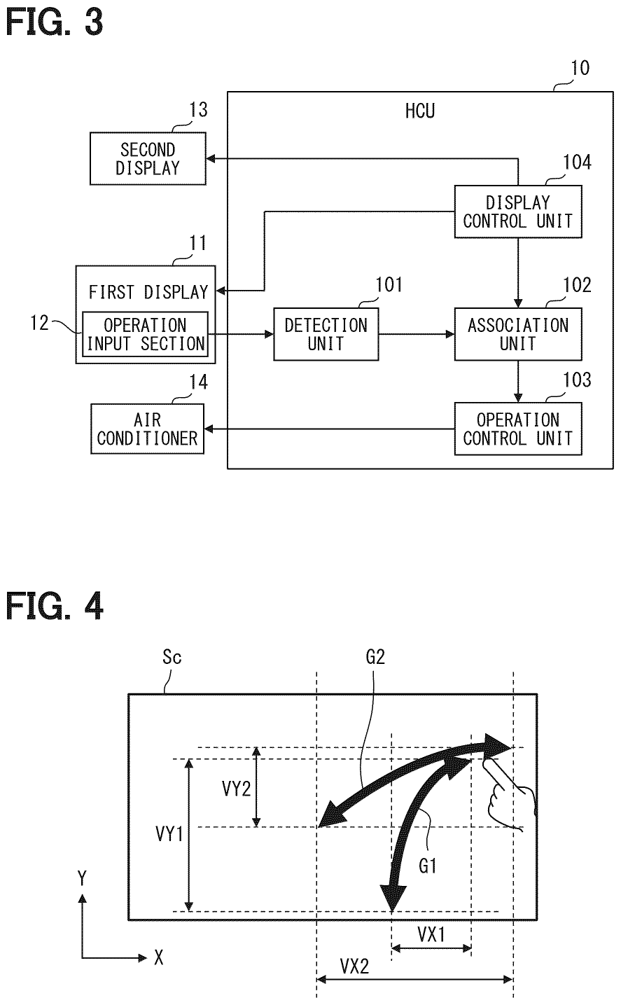

Next, a configuration of the HCU 10 will be described with reference to FIG. 3. As illustrated in FIG. 3, the HCU 10 includes a detection unit 101, an association unit 102, an operation control unit 103, and a display control unit 104 as functional blocks. Some or all of the functions executed by the HCU 10 may be implemented by hardware using one or more ICs or the like. Alternatively, some or all of the functions executed by the HCU 10 may be implemented by a combination of execution of software by a processor and a hardware device. Execution of a process of each functional block of the HCU 10 by a computer corresponds to execution of a vehicle control method.

The detection unit 101 detects a gesture performed by an occupant of the subject vehicle. Processing by the detection unit 101 corresponds to a detection step. The detection unit 101 may detect a gesture performed by the occupant of the subject vehicle based on an input result received by the operation input section 12. The input result is the position information described above.

The gesture detected by the detection unit 101 is a gesture for which at least a line motion of a finger is required. Such a gesture includes a swipe which is a gesture of moving a finger in a specific direction while touching the display screen of the first display 11 and releasing the finger. In addition, a long press drag or the like may be received as the gesture. The long press drag is a gesture of placing a finger at one point on the display screen of the first display 11 for a long time and then moving and releasing the finger. Hereinafter, an example will be described as a case where the detection unit 101 detects a swipe. The gesture detected by the detection unit 101 may be a gesture for which a curved motion of a finger is required, or a gesture for which a linear motion of a finger is required.

In the present embodiment, it is assumed that the detection unit 101 can detect at least a first gesture and a second gesture having a relationship therebetween in which required linear motions of a finger to be input to the operation input section 12 are orthogonal to each other. The required linear motions of a finger to be input to the operation input section 12 can be rephrased as a linear motion of a finger along the display screen of the first display 11 in the present embodiment. The first gesture is a linear motion of a finger in a Y-axis direction described above. The first gesture in the present embodiment can be rephrased as a swipe in the up-down direction of the subject vehicle. The second gesture is a linear motion of a finger in an X-axis direction described above. The second gesture in the present embodiment can be rephrased as a swipe in the right-left direction of the subject vehicle.

The detection unit 101 may distinguish between the first gesture and the second gesture according to a magnitude of change in a direction of motion required for either the first gesture or the second gesture. For example, the detection unit 101 may determine a linear motion of a finger to be the second gesture when a change in the linear motion in the X-axis direction required for the second gesture is equal to or greater than a threshold value. On the other hand, the detection unit 101 may determine the linear motion to be the first gesture when the change is less than the threshold value. Further, the detection unit 101 may determine a linear motion of a finger to be the first gesture when a change in the linear motion in the Y-axis direction required for the first gesture is equal to or greater than a threshold value. On the other hand, the detection unit 101 may determine the linear motion to be the second gesture when the change is less than the threshold value. The threshold value of the change in the X-axis direction and the threshold value of the change in the Y-axis direction may be different.

Here, the distinction between the first gesture and the second gesture will be described with reference to FIG. 4. Sc in FIG. 4 indicates the display screen of the first display 11. G1 in FIG. 4 indicates a trajectory of the first gesture. G2 in FIG. 4 indicates a trajectory of the second gesture. FIG. 4 illustrates an example in which an occupant in the driver's seat performs a gesture with a finger of the left hand. Hereinafter, an example will be described as a case where the driver's seat is on the right side of the subject vehicle and the passenger's seat is on the left side of the subject vehicle. When the present invention is applied to a case where the driver's seat is on the left side of the subject vehicle and the passenger's seat is on the right side of the subject vehicle, the “left” and “right” in the following description may be reversed.

The first gesture and the second gesture are gestures for which a linear motion of a finger is required. However, the first gesture and the second gesture may not be actually input by a linear motion. This is because a range in which a finger is easily moved with respect to the display screen of the first display 11 is narrowed depending on the position of the occupant. For example, when the first gesture and the second gesture are performed with a finger of the left hand of the occupant seated on the right side of the display screen of the first display 11, arc-shaped trajectories are drawn as illustrated in FIG. 4. In this case, it may be difficult to distinguish between the first gesture and the second gesture based on directions in which the trajectories extend, i.e., whether the trajectories extend in the X-axis direction or the Y-axis direction.

However, even when gestures for the first gesture and the second gesture draw the arc-shaped trajectories, the first gesture and the second gesture can be distinguished accurately based on the changes in the trajectories in the X-axis direction and the Y-axis direction. As illustrated in FIG. 4, a change VX2 in a trajectory G2 in the X-axis direction for the second gesture is larger than a change VX1 in a trajectory G1 in the X-axis direction for the first gesture. Therefore, it is possible to distinguish between the first gesture and the second gesture based on whether the change in the trajectory in the X-axis direction is equal to or greater than the threshold value. As illustrated in FIG. 4, a change VY1 in the trajectory G1 in the Y-axis direction for the first gesture is larger than a change VY2 in the trajectory G2 in the Y-axis direction for the second gesture. Therefore, it is possible to distinguish between the first gesture and the second gesture based on whether the change in the trajectory in the Y-axis direction is equal to or greater than the threshold value.

The first gesture and the second gesture may be distinguished from each other by, for example, a slope of an approximate straight line obtained by approximating a trajectory to a straight line by a least squares method or the like. For example, the first gesture and the second gesture may be distinguished depending on whether the slope of the approximate straight line is close to a slope of a trajectory of motion required for the first gesture or a slope of a trajectory of motion required for the second gesture.

The association unit 102 associates the gesture detected by the detection unit 101 with an operation of a device provided in the subject vehicle. Processing by the association unit 102 corresponds to an association step. In an example of the present embodiment, the association unit 102 associates the gesture detected by the detection unit 101 with an operation of the air conditioner 14. In the example of the present embodiment, the first gesture is associated with temperature adjustment of conditioned air. On the other hand, the second gesture is associated with air-volume adjustment of the conditioned air. That is, different gestures are associated with different operations.

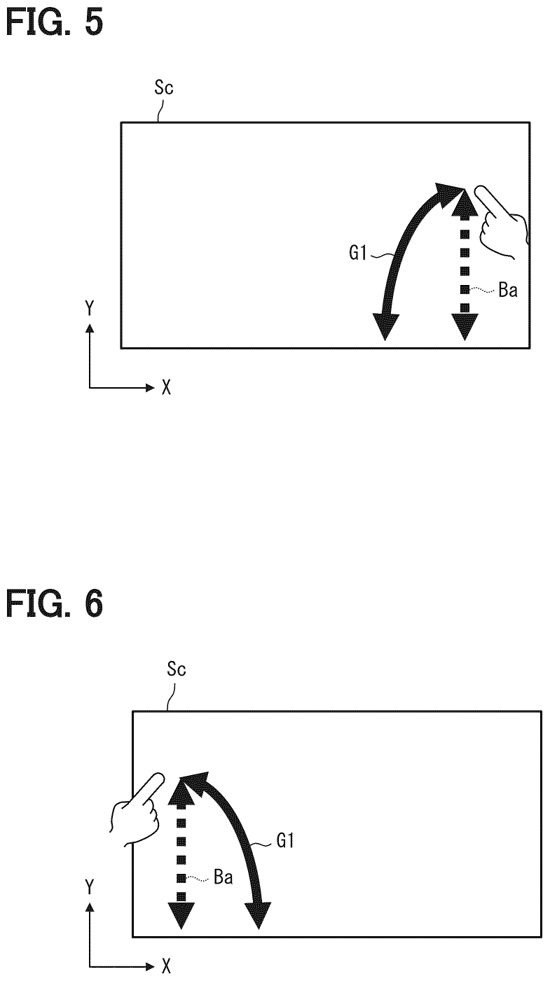

In addition, the association unit 102 associates different operations of the position-specific operations with gestures detected as a common gesture by the detection unit 101 according to a deviation direction of the trajectory of the gesture from a reference trajectory. The reference trajectory is a trajectory of motion required by the common gesture. For example, in a case where a gesture is detected as the first gesture, when a deviation direction of the trajectory of the gesture is leftward from the reference trajectory, in other words, the trajectory deviates (i.e., swells) leftward from the reference trajectory, the gesture may be associated with one of the position-specific operations for a position rightward of the operation input section 12. That is, the gesture is associated with temperature adjustment on the driver's seat side. This is because, as shown in FIG. 5, when the gesture is performed as the first gesture on the display screen of the first display 11 by the occupant seated on the driver's seat, the trajectory of the gesture deviates leftward from the reference trajectory Ba shown in FIG. 5. On the other hand, when a deviation direction of the trajectory of a gesture is rightward from the reference trajectory, in other words, the trajectory deviates (i.e., swells) rightward from the reference trajectory, the gesture may be associated with another of the position-specific operations for a position leftward of the operation input section 12. That is, the gesture is associated with temperature adjustment on the passenger's seat side. This is because, as shown in FIG. 6, when the gesture is performed as the first gesture on the display screen of the first display 11 by the occupant seated on the passenger's seat, the trajectory of the gesture deviates rightward from the reference trajectory Ba shown in FIG. 6. In addition, when a downward motion of the first gesture is detected by the detection unit 101, the association unit 102 may associate the gesture with temperature adjustment for decreasing the temperature. On the other hand, when a upward motion of the first gesture is detected by the detection unit 101, the association unit 102 may associate the gesture with temperature adjustment for increasing the temperature.

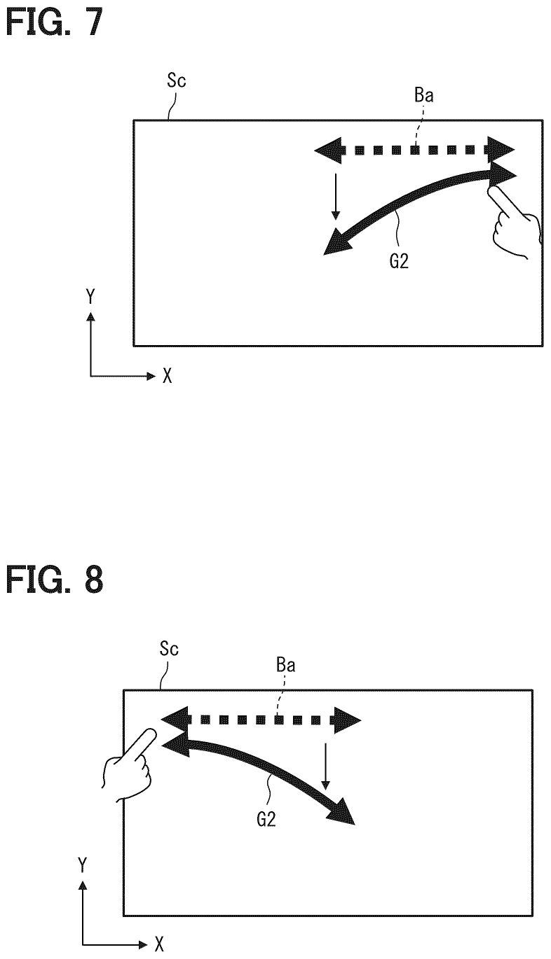

For example, in a case where a gesture is detected as the second gesture, when a deviation direction of the trajectory of the gesture is left-downward from the reference trajectory, in other words, the trajectory deviates (i.e., spreads) left-downward from the reference trajectory, the gesture may be associated with one of the position-specific operations for the position rightward of the operation input section 12. That is, the gesture is associated with air-volume adjustment on the driver's seat side. This is because, as shown in FIG. 7, when the gesture is performed as the second gesture on the display screen of the first display 11 by the occupant seated on the driver's seat, the trajectory of the gesture deviates left-downward from the reference trajectory Ba shown in FIG. 7. On the other hand, when a deviation direction of the trajectory of a gesture is right-downward from the reference trajectory, in other words, the trajectory deviates (i.e., spreads) right-downward from the reference trajectory, the gesture may be associated with another of the position-specific operations for the position leftward of the operation input section 12. That is, the gesture is associated with air-volume adjustment on the passenger's seat side. This is because, as shown in FIG. 8, when the gesture is performed as the second gesture on the display screen of the first display 11 by the occupant seated on the passenger's seat, the trajectory of the gesture deviates rightward from the reference trajectory Ba shown in FIG. 8. In addition, when a leftward motion of the second gesture is detected by the detection unit 101, the association unit 102 may associate the gesture with air-volume adjustment for decreasing the air volume. On the other hand, when a rightward motion of the second gesture is detected by the detection unit 101, the association unit 102 may associate the gesture with air-volume adjustment for increasing the air volume.

The operation control unit 103 can execute the position-specific operations. Processing by the operation control unit 103 corresponds to an operation control step. In an example of the present embodiment, the operation control unit 103 causes the air conditioner 14 to execute temperature adjustments and air-volume adjustments that are different between the driver's seat and the passenger's seat of the subject vehicle. The temperature adjustment and the air-volume adjustment on the driver's seat may be executed by conditioning of the conditioned air blown out from air outlets for the driver's seat. The temperature adjustment and the air-volume adjustment on the passenger's seat may be executed by conditioning of the conditioned air blown out from air outlets for the passenger's seat. The operation control unit 103 causes the air conditioner 14 to execute an operation associated by the association unit 102 with a gesture detected by the detection unit 101.

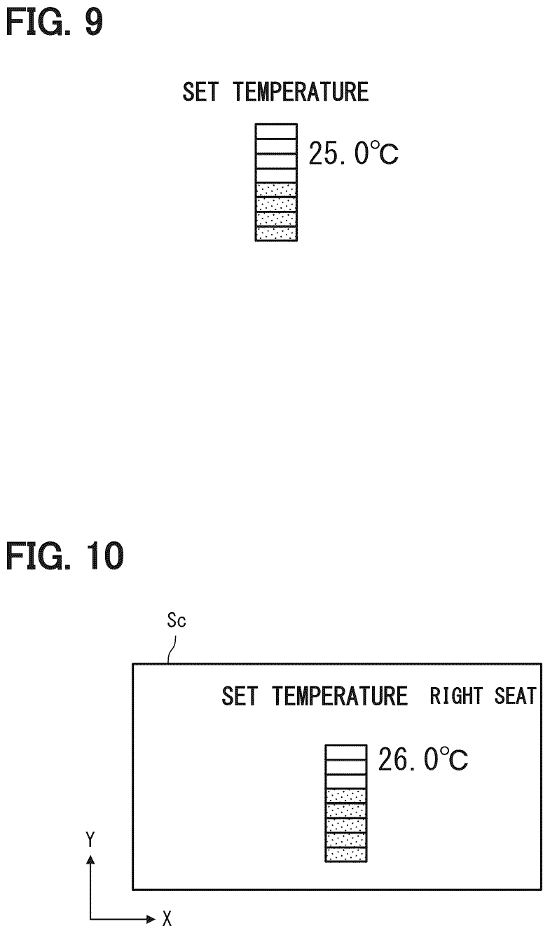

The display control unit 104 controls display on the first display 11 and the second display 13. The display control unit 104 controls display on a display provided in the vehicle cabin is controlled. The display control unit 104 may causes at least the second display 13 to display information for the position-specific operations. This is because a driver can easily check the information displayed on the display screen of the second display 13 even when the driver is driving. For example, as illustrated in FIG. 9, information indicating the set temperature adjusted by the position-specific operations may be displayed on the second display 13. In this case, information indicating a set temperature for the temperature adjustment on the driver's seat may be displayed on a part of the display screen of the second display 13 in front of the driver's seat. On the other hand, information indicating a set temperature for the temperature adjustment on the passenger's seat may be displayed on a part of the display screen of the second display 13 in front of the passenger's seat. In addition to the set temperature for the temperature adjustment, information indicating a set air volume for the air-volume adjustment may be displayed. The information for the position-specific operations may also be displayed on the first display 11.

When the operation control unit 103 causes the air conditioner 14 to execute an operation associated by the association unit 102 with a gesture detected by the detection unit 101, the display control unit 104 may cause the first display 11 and the second display 13 to display information (hereinafter, FB information) for providing an occupant with a feedback that the operation is being executed. The FB information may be information according to change in settings by an operation in the operation control unit 103. For example, in a case where the temperature adjustment for increasing the set temperature on the driver's seat is performed, as illustrated in FIG. 10, information such as “26.0° C.” indicating the value of the set temperature may be displayed on the first display 11 together with information such as “RIGHT SEAT” and “SET TEMPERATURE” for distinguishing the position-specific operations. The same display may be displayed on the second display 13 in front of the driver's seat. In the case of displaying on the second display 13, the user can distinguish between the operation for the driver's seat and the operation for the passenger seat depending on the display location. Therefore, the display such as “RIGHT SEAT” may be omitted. The display of the FB information described above is hereinafter referred to as FB display.

In addition, the display control unit 104 may be configured to switch the display that executes the FB display according to whether the operation for the driver seat is executed or the operation for the passenger seat is executed. For example, when the operation control unit 103 causes the air conditioner 14 to execute an operation for the passenger's seat associated by the association unit 102 with a gesture detected by the detection unit 101, the display control unit 104 may cause both the first display 11 and the second display 13 to display FB information. On the other hand, when the operation control unit 103 causes the air conditioner 14 to execute an operation for the driver's seat associated by the association unit 102 with a gesture detected by the detection unit 101, the display control unit 104 may cause only the second display 13 to display FB information among the first display 11 and the second display 13.

An occupant in the passenger's seat is not required to look ahead. Therefore, the occupant can look at both the display screen of the first display 11 and the display screen of the second display 13. Regarding this, according to the above configurations, when the operation for the passenger's seat is executed, the FB information is displayed on both the first display 11 and the second display 13. Therefore, the FB information can be confirmed by the occupant regardless of whether the occupant in the front passenger's seat looks at the display screen of the first display 11 or the display screen of the second display 13. On the other hand, an occupant in the driver's seat is required to look ahead. Therefore, the occupant may look at the display screen of the second display 13 but may not look at the display screen of the first display 11. Regarding this, according to the above configurations, when the operation for the driver's seat is executed, the FB information is not displayed on the first display 11. Therefore, unnecessary display of FB information that is unlikely to be viewed by the driver can be reduced. When the vehicle is operated in automated driving or stopped, the driver is not required to look ahead. Therefore, in this case, even when the operation for the driver's seat is executed, the FB information may be displayed on both the first display 11 and the second display 13 in the same manner as the operation for the passenger's seat.

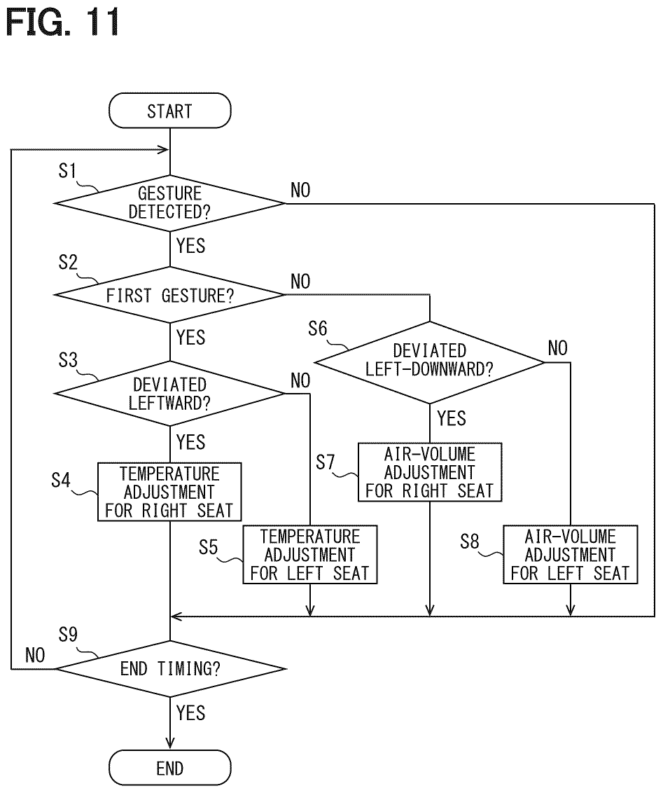

Here, an example of a flow of a process (hereinafter, referred to as a position-specific process) related to the position-specific operations according to a gesture in the HCU 10 will be described with reference to the flowchart of FIG. 11. The process shown in FIG. 11 may be started, for example, in response to a switch (power switch) for starting an internal combustion engine or a motor generator of the subject vehicle being turned on.

In step S1, when a gesture is detected by the detection unit 101 (YES in S1), the process proceeds to step S2. On the other hand, when the gesture is not detected by the detection unit 101 (NO in S1), the process proceeds to step S9. In the present embodiment, the first gesture and the second gesture correspond to gestures detected as gestures by the detection unit 101.

In step S2, when the gesture detected by the detection unit 101 is the first gesture (YES in S2), the process proceeds to step S3. On the other hand, when the gesture detected by the detection unit 101 is the second gesture (NO in S2), the process proceeds to step S6.

In step S3, when the deviation direction of the trajectory of the first gesture from the reference trajectory is leftward, in other words, the trajectory of the first gesture swells leftward (YES in step S3), the process proceeds to step S4. On the other hand, when the deviation direction of the trajectory of the first gesture from the reference trajectory is rightward, in other words, the trajectory of the first gesture swells rightward (NO in step S3), the process proceeds to step S5.

In step S4, the association unit 102 associates the gesture with temperature adjustment for a right seat. In the example of the present embodiment, the right seat corresponds to the driver's seat. Then, the operation control unit 103 executes the temperature adjustment for the right seat, and proceeds to step S9. In step S5, the association unit 102 associates the gesture with temperature adjustment for a left seat. In the example of the present embodiment, the left seat corresponds to the passenger's seat. Then, the operation control unit 103 executes the temperature adjustment for the left seat, and proceeds to step S9.

In step S6, when the deviation direction of the trajectory of the second gesture from the reference trajectory is left-downward, in other words, the trajectory of the second gesture deviates left-downward (YES in step S6), the process proceeds to step S7. On the other hand, when the deviation direction of the trajectory of the second gesture from the reference trajectory is right-downward, in other words, the trajectory of the second gesture deviates right-downward (NO in step S6), the process proceeds to step S8.

In step S7, the association unit 102 associates the gesture with air-volume adjustment for the right seat. Then, the operation control unit 103 executes the air-volume adjustment for the right seat, and proceeds to step S9. In step S8, the association unit 102 associates the gesture with air-volume adjustment for the left seat. Then, the operation control unit 103 executes the air-volume adjustment for the left seat, and proceeds to step S9.

In step S9, when it is the end timing of the position-specific process (YES in S9), the position-specific process is ended. On the other hand, when it is not the end timing of the position-specific process (NO in S9), the process returns to step S1 to repeat the process. An example of the end timing of the position-specific process is a timing at which the power switch is turned off.

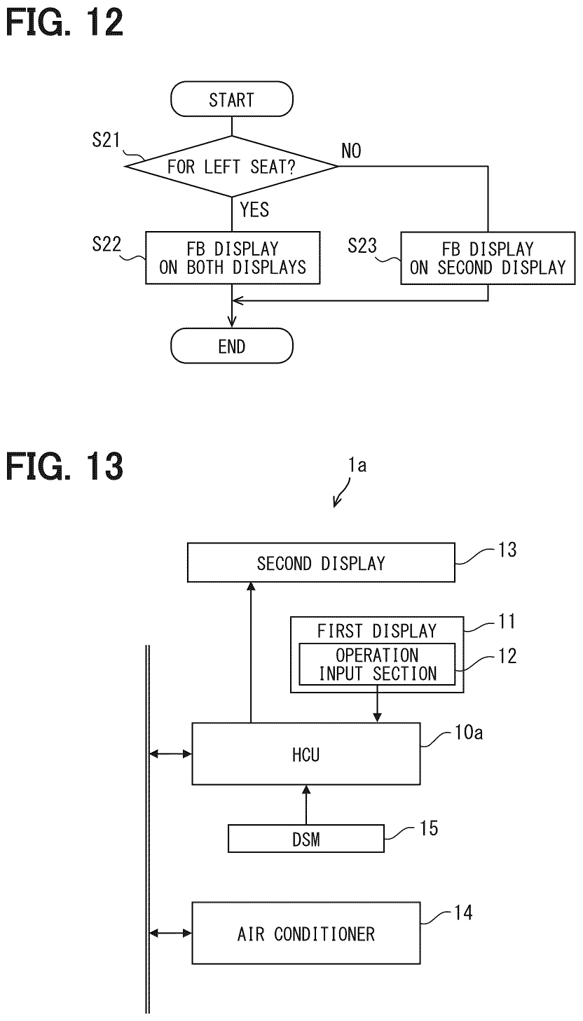

Next, an example of a flow of a process (hereinafter, referred to as an FB display process) related to the FB display in the HCU 10 will be described with reference to the flowchart of FIG. 12. The flowchart of FIG. 12 may start when the position-specific operations are executed.

In step S21, when a position-specific operation for the left seat is executed (YES in step S21), the process proceeds to step S22. On the other hand, when a position-specific operation for the right seat is executed (NO in step S21), the process proceeds to step S23. In step S22, the display control unit 104 causes the FB information to be displayed on both the first display 11 and the second display 13, and ends the FB display process. On the other hand, in step S23, the display control unit 104 causes the FB information to be displayed only on the second display 13 among the first display 11 and the second display 13, and ends the FB display process.

As described above, a trajectory of a gesture in which a linear motion of a finger is required generally has a specific tendency in deviation direction according to a position of an occupant relative to the operation input section 12. This is because a range in which a body part used for the gesture is easily moved differs depending on the position of the occupant relative to the position where the gesture is detected. Regarding this, according to the configuration of the first embodiment, different operations of the position-specific operations are associated with gestures detected as a common gesture according to a direction of deviation of a trajectory of a linear motion of a finger detected as the common gesture from a trajectory of the line motion required by the common gesture. Then, the associated operation is executed. Therefore, the common gesture can cause execution of the different position-specific operations according to the position of the occupant relative to the position at which the gesture is detected. Therefore, the position-specific operations can be executed according to the position of the occupant who has performed the gesture. As a result, different operations can be executed using the common gesture while operations meeting necessities can be executed more accurately. In the configuration of the first embodiment, a gesture input is performed on the display screen of the first display 11 which is difficult to be checked during driving while the gesture input is not performed on the display screen of the second display 13 which is easy to be checked during driving. Therefore, the deviation of the trajectory described above is particularly likely to occur. Therefore, in particular, it is possible to accurately associate the position-specific operations with the gesture.

### Second Embodiment

In the first embodiment, the FB information is displayed only on the second display 13 among the first display 11 and the second display 13 when a position-specific operation for the driver's seat is executed. However, the display manner is not necessarily limited thereto. For example, in a second embodiment, when the position-specific operation for the driver's seat is executed, the FB information may be displayed only on the display screen of the display toward which the driver is facing among the first display 11 and the second display 13. Hereinafter, an example of the second embodiment will be described with reference to the drawings.

First, a configuration of a vehicle system 1a according to the second embodiment will be described with reference to FIG. 13. As illustrated in FIG. 13, the vehicle system according to the second embodiment includes an HCU 10a (i.e., Human Machine Interface Control Unit), a first display 11, an operation input section 12, a second display 13, an air conditioner 14, and a DSM 15 (i.e., Driver Status Monitor). The vehicle system 1a of the second embodiment is similar to the vehicle system 1 of the first embodiment, except for the vehicle system 1a including the HCU 10a instead of the HCU 10 and including the DSM 15.

The DSM 15 includes a near-infrared light source, a near-infrared camera, and a control unit for controlling these devices. For example, the DSM 15 is disposed in a posture in which the near-infrared camera faces the driver's seat in the vehicle. Examples of a place where the DSM 15 is disposed include an upper surface of an instrument panel, a vicinity of a rearview mirror, and a steering column cover. The DSM 15 uses the near-infrared camera to capture the driver's face to which the near-infrared light is emitted from the near-infrared light source. An image captured by the near-infrared camera is subjected to image analysis by the controller. The control unit detects at least an eye direction of the driver from a captured image (hereinafter, referred to as a face image) obtained by capturing the head of the driver.

The control unit of the DSM 15 detects parts such as the contour of the face, the eyes, the nose, and the mouth from the face image via image recognition processing. The control unit detects the face direction of the driver from the relative positional relationship between the parts. Further, the control unit detects a pupil and a corneal reflection from the captured image via image recognition processing. Then, the eye direction is detected from the detected face direction and the positional relationship between the detected pupil and the corneal reflection. The eye direction may be expressed as a straight line starting from an eye point which is the position of the eyes of the driver. The eye point may be specified as coordinates in a three-dimensional space having a predetermined position in the vehicle as a coordinate origin, for example. The coordinates of the eye point may be specified based on a predefined correspondence relationship between the position of the eye in the image captured by the near-infrared camera and the position in the three-dimensional space. The DSM 15 sequentially detects the eye direction of the driver and outputs the detected eye direction to the ECU 10.

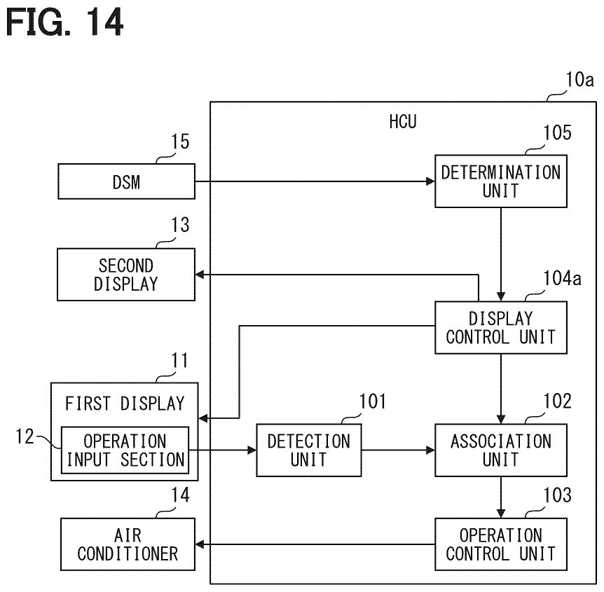

Next, a configuration of the HCU 10a will be described with reference to FIG. 14. As illustrated in FIG. 14, the HCU 10 a includes a detection unit 101, an association unit 102, an operation control unit 103, a display control unit 104a, and a determination unit 105 as functional blocks. The HCU 10a is similar to the HCU 10 of first embodiment except that a display control unit 104a is provided instead of the display control unit 104 and that a determination unit 105 is provided. The HCU 10a also corresponds to the vehicle control device. The execution of the processing of each functional block of the HCU 10a by the computer also corresponds to the execution of the vehicle control method.

The determination unit 105 determines whether a driver who is the occupant in the driver's seat is facing in a direction toward the display screen of the first display. The determination unit 105 may determine this based on the eye direction of the driver outputted from the DSM 15. The determination unit 105 may also determine whether the driver is facing the display screen of the second display 13.

The display control unit 104a is similar to the display control unit 104 of the first embodiment except that a part of the FB display process is different. Similarly to the display control unit 104, when the operation control unit 103 causes the air conditioner 14 to execute an operation for the passenger's seat associated by the association unit 102 with a gesture detected by the detection unit 101, the display control unit 104a causes FB information to be displayed on both the first display 11 and the second display 13.

On the other hand, when the operation control unit 103 causes the air conditioner 14 to execute an operation for the driver's seat associated by the association unit 102 with a gesture detected by the detection unit 101 and the determination unit 105 determines that the driver faces the display screen of the first display 11, the display control unit 104a causes the FB information to be displayed only on the first display 11 among the first display 11 and the second display 13. Further, when the operation control unit 103 causes the air conditioner 14 to execute an operation for the driver's seat associated by the association unit 102 with a gesture detected by the detection unit 101 and the determination unit 105 determines that the driver does not face the display screen of the first display 11, the display control unit 104a causes the FB information to be displayed only on the second display 13 among the first display 11 and the second display 13.

The driver is required to look forward. Therefore, when the driver does not face the display screen of the first display 11, it is considered that the driver faces in a direction in which the driver easily check the display screen of the second display 13. Therefore, according to the above configuration, the FB information can be displayed on the display screen that is highly likely to be viewed by the driver while reducing unnecessary display of the FB information that is less likely to be viewed by the driver.

When the operation control unit 103 causes the air conditioner 14 to execute an operation for the driver's seat associated by the association unit 102 with a gesture detected by the detection unit 101 and the determination unit 105 determines that the driver faces the display screen of the second display 13, the display control unit 104a may cause the FB information to be displayed only on the second display 13 among the first display 11 and the second display 13.

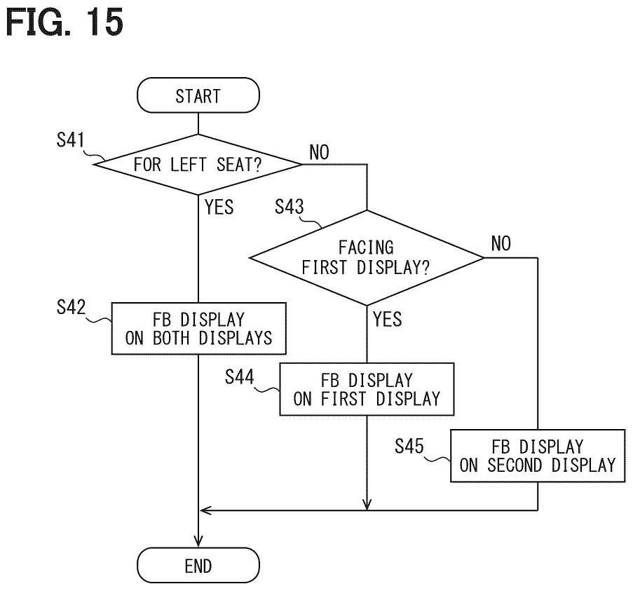

An example of the flow of the FB display process in the HCU 10a will be described with reference to the flowchart of FIG. 15. Similarly to the flowchart of FIG. 12, the flowchart of FIG. 15 may be started when the position-specific operations are executed.

In step S41, when a position-specific operation for the left seat is executed (YES in step S41), the process proceeds to step S42. On the other hand, when a position-specific operation for the right seat is executed (NO in step S41), the process proceeds to step S43. In step S42, the display control unit 104a causes the FB information to be displayed on both the first display 11 and the second display 13, and ends the FB display process.

In step S43, when the determination unit 105 determines that the driver faces the display screen of the first display 11 (YES in step S43), the process proceeds to step S44. On the other hand, when the determination unit 105 determines that the driver does not face the display screen of the first display 11 (NO in S43), the process proceeds to step S45.

In step S44, the display control unit 104a causes the FB information to be displayed only on the first display 11 among the first display 11 and the second display 13, and ends the FB display process. On the other hand, In step S45, the display control unit 104a causes the FB information to be displayed only on the second display 13 among the first display 11 and the second display 13, and ends the FB display process.

### Third Embodiment

In the second embodiment, the display that displays the FB information is switched according to whether the driver faces the display screen of the first display 11 or the display screen of the second display 13, but the present invention is not necessarily limited thereto. For example, in a third embodiment, when the second display 13 is composed of multiple displays, the display showing the FB information may be switched according to which display screen of the multiple displays the driver is facing.

For example, a case where the second display 13 includes a meter MID (Multi Information Display) and a HUD (Head-Up Display) will be described. The meter MID30 is a display provided in front of the driver's seat in the vehicle cabin. As an example, the meter MID may be arranged on the meter panel. The HUD is provided, for example, on an instrument panel in the vehicle cabin. The HUD projects a display image formed by an projector onto a predetermined projection area on the front windshield as a projection member. A light of the display image reflected by the front windshield to an inside of a vehicle compartment is perceived by the driver seated in the driver's seat. As a result, the driver can visually recognize the virtual image of the display image formed in front of the front windshield which is superimposed on a part of the foreground landscape. The HUD may be configured to project the display image onto a combiner instead of the front windshield. The display screen of the HUD is located above the display surface of the meter MID.

In the third embodiment, the determination unit 105 determines whether the driver faces the display screen of the meter MID or the HUD included in the second display 13. This process is may be executed only when the driver is determined not to face the display screen of the first display 11. Hereinafter, the display screen of the meter MID is referred to as a first display screen, and the display screen of the HUD is referred to as a second display screen.

In the third embodiment, when the operation control unit 103 causes the air conditioner 14 to execute an operation for the driver's seat associated by the association unit 102 with a gesture detected by the detection unit 101 and the determination unit 105 determines that the driver faces the first display screen of the multiple displays of the second display 13, the display control unit 104a causes the FB information to be displayed only on the meter MID among the meter MID and the HUD. When the operation control unit 103 causes the air conditioner 14 to execute an operation for the driver's seat associated by the association unit 102 with a gesture detected by the detection unit 101 and the determination unit 105 determines that the driver faces the second display screen of the multiple displays of the second display 13, the display control unit 104a causes the FB information to be displayed only on the HUD among the meter MID and the HUD.

Here, the case where the meter MID and the HUD are included in the second display 13 has been described as an example, but the present invention is not necessarily limited thereto. The same applies to a case where the second display 13 includes another display. The other display included in the second display 13 may include an upper screen of divided two upper and lower screens of the first display 11.

### Fourth Embodiment

In the above-described embodiments, the first gesture and the second gesture have been described as examples of the gestures detected by the detection unit 101, but the present invention is not necessarily limited thereto. For example, only one of the first gesture and the second gesture may be used. In this case, the process of detecting the first gesture and the second gesture separately by the detection unit 101 may be omitted.

### Fifth Embodiment

In the above-described embodiments, the position-specific operations are the operations of the air conditioner 14 different for the driver's seat and the passenger's seat, but the present invention is not necessarily limited thereto. The position-specific operations may be operations of an in-vehicle device provided in the vehicle other than the air conditioner 14. Examples other than the air conditioner 14 include a sound output device that can change the sound volume for each position of the vehicle in a sound volume operation. The position-specific operations are not limited to operations different between the driver's seat and the passenger's seat as long as the operations are different according to positions in the vehicle. For example, different operations may be executed at positions on right and left sides of the rear seat. For the air conditioning in the rear seat, seat air conditioning provided in the seat may be used.

### Sixth Embodiment

In the above-described embodiments, the position-specific operations are different for positions rightward and leftward of the operation input section 12 in the right-left direction of the subject vehicle, but the present invention is not necessarily limited thereto. The position-specific operations may be different for positions frontward and rearward of the operation input section 12 in a front-rear direction of the subject vehicle. For example, the operations may be different for a front seat and a rear seat of the subject vehicle. In this case, the first display 11 may be provided so that the display screen faces the ceiling of the subject vehicle. In this case, the first gesture described above may be a motion in the front-rear direction of the subject vehicle. In addition, the association unit 102 may associate the operation for the front seat or the operation for the rear seat with a common gesture performed by an occupant by using the direction of deviation of the trajectory of the gesture that is different depending on whether the occupant performing the common gesture is positioned frontward or rearward of the operation input section 12.

### Seventh Embodiment

In the above-described embodiments, the case where the operation input section 12 is a touch sensor has been described as an example, but the present invention is not necessarily limited thereto. For example, the operation input section 12 may be a sensor that detects a gesture by forming a two-dimensional image or a three-dimensional image. Examples of such a sensor include a near-infrared sensor, a far-infrared sensor, and a camera.

### Eighth Embodiment

In the above-described embodiment, the display screen of the display extends from the left A pillar to the right A pillar and is used as the second display 13, but the present invention is not necessarily limited thereto. For example, the second display 13 may be a display having a display screen narrower than that of the display in which the display surface extends from the left A pillar to the right A pillar. For example, a meter MID, a HUD, or the like having a display screen limited within a range in front of the driver's seat may be used.

### Ninth Embodiment

In the above-described embodiments, display related to the gesture detection can be displayed on both the first display 11 and the second display 13, but the present invention is not necessarily limited thereto. The display related to the gesture detection may be displayed only on the first display 11. The vehicle may not include the second display 13.

The control device and the control method described in the present disclosure may be implemented by a special purpose computer which includes a processor programmed to execute one or more functions executed by computer programs. Also, the device and the method therefor which have been described in the present disclosure may be also realized by a special purpose hardware logic circuit. Alternatively, the device and the method described in the present disclosure may be implemented by one or more special purpose computers configured by a combination of a processor executing a computer program and one or more hardware logic circuits. The computer program may also be stored in a computer-readable non-transitory tangible storage medium as instructions to be executed by a computer.

While the present disclosure has been described with reference to embodiments thereof, it is to be understood that the disclosure is not limited to the embodiments and constructions. To the contrary, the present disclosure is intended to cover various modification and equivalent arrangements. In addition, while the various elements are shown in various combinations and configurations, which are exemplary, other combinations and configurations, including more, less or only a single element, are also within the spirit and scope of the present disclosure.

What is claimed is:

1. A vehicle control device comprising:
a processor and a memory that stores instructions configured to, when executed by the processor, cause the processor to:
detect a gesture due to a motion of a body part of an occupant of a vehicle, the gesture being an input different from an input via touching of a button image and being not depending on an image on a display,
associate the gesture with an operation of an in-vehicle device provided in the vehicle,
cause the in-vehicle device to execute the operation associated with the gesture,
cause the in-vehicle device to execute position-specific operations that are different for respective positions in a vehicle cabin of the vehicle,
detect the gesture that requires a line motion of the body part, and
associate different operations of the position-specific operations with gestures detected as a common gesture according to a direction of trajectory deviation, the trajectory deviation being deviation of a trajectory of a line motion of the body part detected as the common gesture from a trajectory of the line motion required by the common gesture.

2. The vehicle control device according to claim 1, wherein
execution of the instructions further causes the processor to
control display on the display provided in the vehicle cabin, and
cause the display to display information for the position-specific operations.

3. The vehicle control device according to claim 2, wherein
execution of the instructions further causes the processor to
detect the gesture that requires the line motion of the body part based on an input result received by an input device that is provided in the vehicle cabin and configured to receive an input of the gesture, and
control display on the display including a first display and a second display,
cause at least the second display to display the information for the position-specific operations,
the first display is a touch panel including the input device and having a display screen located at a position other than in front of a driver's seat in the vehicle, and
the second display has at least a display screen extending from a position in front of the driver's seat to a position in front of a passenger's seat in the vehicle and does not include the input device.

4. The vehicle control device according to claim 1, wherein
execution of the instructions further causes the processor to
control display on the display provided in the vehicle cabin, and
cause the display to display information for providing the occupant with a feedback that the operation associated with the gesture is being executed when the in-vehicle device is caused to execute the operation.

5. The vehicle control device according to claim 3, wherein
the position-specific operations are different for the driver's seat and the passenger's seat in the vehicle, and
execution of the instructions further causes the processor to
determine whether a driver who is the occupant in the driver's seat is facing the display screen of the first display,
cause both the first display and the second display to display information for providing the occupant with a feedback that the operation associated with the gesture is being executed when the in-vehicle device is caused to execute the operation for the passenger's seat,
cause only the first display among the first display and the second display to display information for providing the occupant with a feedback that the operation associated with the gesture is being executed when the in-vehicle device is caused to execute the operation for the driver's seat, and the driver is determined to be facing the display screen of the first display, and
cause only the second display among the first display and the second display to display information for providing the occupant with a feedback that the operation associated with the gesture is being executed when the in-vehicle device is caused to execute the operation for the driver's seat, and the driver is determined not to be facing the display screen of the first display.

6. The vehicle control device according to claim 3, wherein
the position-specific operations executed are different for the driver's seat and the passenger's seat in the vehicle, and
execution of the instructions further causes the processor to
cause both the first display and the second display to display information for providing the occupant with a feedback that the operation associated with the gesture is being executed when the in-vehicle device is caused to execute the operation for the passenger's seat,
cause only the second display among the first display and the second display to display information for providing the occupant with a feedback that the operation associated with the gesture is being executed when the in-vehicle device is caused to execute the operation for the driver's seat.

7. A vehicle control device comprising:
a processor and a memory that stores instructions configured to, when executed by the processor, cause the processor to:
detect a gesture due to a motion of a body part of an occupant of a vehicle,
associate the gesture with an operation of an in-vehicle device provided in the vehicle,
cause the in-vehicle device to execute the operation associated with the gesture,
cause the in-vehicle device to execute position-specific operations that are different for respective positions in a vehicle cabin of the vehicle,
detect the gesture that requires a line motion of the body part,
associate different operations of the position-specific operations with gestures detected as a common gesture according to a direction of trajectory deviation, the trajectory deviation being deviation of a trajectory of a line motion of the body part detected as the common gesture from a trajectory of the line motion required by the common gesture,
control display on the display provided in the vehicle cabin,
cause the display to display information for the position-specific operations,
detect the gesture that requires the line motion of the body part based on an input result received by an input device that is provided in the vehicle cabin and configured to receive an input of the gesture, and
control display on the display including a first display and a second display,
the first display is a touch panel including the input device and having a display screen located at a position other than in front of a driver's seat in the vehicle,
the second display has at least a display screen extending from a position in front of the driver's seat to a position in front of a passenger's seat in the vehicle and does not include the input device,
the position-specific operations are different for the driver's seat and the passenger's seat in the vehicle, and
execution of the instructions further causes the processor to
cause at least the second display to display the information for the position-specific operations,
determine whether a driver who is the occupant in the driver's seat is facing the display screen of the first display,
cause both the first display and the second display to display information for providing the occupant with a feedback that the operation associated with the gesture is being executed when the in-vehicle device is caused to execute the operation for the passenger's seat,
cause only the first display among the first display and the second display to display information for providing the occupant with a feedback that the operation associated with the gesture is being executed when the in-vehicle device is caused to execute the operation for the driver's seat, and the driver is determined to be facing the display screen of the first display, and
cause only the second display among the first display and the second display to display information for providing the occupant with a feedback that the operation associated with the gesture is being executed when the in-vehicle device is caused to execute the operation for the driver's seat, and the driver is determined not to be facing the display screen of the first display.

8. The vehicle control device according to claim 1, wherein
execution of the instructions further causes the processor to
detect the gesture that requires a linear motion of the body part based on an input result received by an input device that is provided in the vehicle cabin and configured to receive an input of the gesture,
detect, as the gesture, at least a first gesture and a second gesture having a relationship in which linear motions of the body part required to be input to the input device are orthogonal to each other,
detect the gesture by distinguishing between the first gesture and the second gesture according to a magnitude of change in a trajectory of a linear motion of the body part detected as the gesture in a direction of a linear motion required by either the first gesture or the second gesture, and
associate different operations of the position-specific operations with the gestures detected as the common gesture according to a direction of trajectory deviation, the trajectory deviation being deviation of a trajectory of a linear motion of the body part detected as the common gesture from a trajectory of the linear motion required by the common gesture.

9. The vehicle control device according to claim 1, wherein
execution of the instructions further causes the processor to detect the gesture that requires the line motion of the body part based on an input result received by an input device that is provided in the vehicle cabin and configured to receive an input of the gesture, and
the position-specific operations are different for positions leftward and rightward of the input device in a right-left direction of the vehicle.

10. A vehicle control method executed by at least one processor, the method comprising:
detecting a gesture due to a motion of a body part of an occupant of a vehicle, the gesture being an input different from an input via touching of a button image and being not depending on an image on a display;
associating the gesture detected in the detecting with an operation of an in-vehicle device provided in the vehicle; and
controlling the in-vehicle device to execute the operation associated in the associating with the gesture detected in the detecting, wherein
the controlling includes controlling the in-vehicle device to execute position-specific operations that are different for respective positions in a vehicle cabin of the vehicle,
the detecting includes detecting the gesture that requires a line motion of the body part, and
the associating includes associating different operations of the position-specific operations to gestures detected as a common gesture according to a direction of trajectory deviation, the trajectory deviation being deviation of a trajectory of a line motion of the body part detected as the common gesture from a trajectory of the line motion required by the common gesture.

11. A vehicle control method executed by at least one processor, the method comprising:
detecting a gesture due to a motion of a body part of an occupant of a vehicle;
associating the gesture detected in the detecting with an operation of an in-vehicle device provided in the vehicle; and
controlling the in-vehicle device to execute the operation associated in the associating with the gesture detected in the detecting, wherein
the controlling includes controlling the in-vehicle device to execute position-specific operations that are different for respective positions in the vehicle cabin of the vehicle,
the detecting includes detecting the gesture that requires a line motion of the body part,
the associating includes associating different operations of the position-specific operations to gestures detected in the detecting as a common gesture according to a direction of trajectory deviation, the trajectory deviation being deviation of a trajectory of a line motion of the body part detected as the common gesture from a trajectory of the line motion required by the common gesture,
the position-specific operations executed in the controlling are different for the driver's seat and the passenger's seat in the vehicle,
the method further comprises controlling display on a display provided in the vehicle cabin,
the controlling of the display includes causing the display to display information for the position-specific operations,
the detecting includes detecting the gesture that requires the line motion of the body part based on an input result received by an input device that is provided in the vehicle cabin and configured to receive an input of the gesture,
the controlling of the display includes controlling displays on a first display and a second display included in the display,
the first display is a touch panel including the input device and having a display screen located at a position other than in front of a driver's seat in the vehicle,
the second display has at least a display screen extending from a position in front of the driver's seat to a position in front of a passenger's seat in the vehicle and does not include the input device,
the method further comprises determining whether a driver who is the occupant in the driver's seat is facing the display screen of the first display,
the controlling of the display further includes:
causing both the first display and the second display to display information for providing the occupant with a feedback that the operation associated in the associating is being executed when the in-vehicle device is caused in the controlling of the in-vehicle device to execute the operation for the passenger's seat,
causing only the first display among the first display and the second display to display information for providing the occupant with a feedback that the operation associated in the associating is being executed when the in-vehicle device is caused in the controlling of the in-vehicle device to execute the operation for the driver's seat, and the driver is determined in the determining to be facing the display screen of the first display, and
causing only the second display among the first display and the second display to display information for providing the occupant with a feedback that the operation associated in the associating is being executed when the in-vehicle device is caused in the controlling of the in-vehicle device to execute the operation for the driver's seat, and the driver is determined in the determining not to be facing the display screen of the first display.
